(19) United States
(12) Patent Application Publication
(10) Pub. No.: US 2015/0347477 A1
(43) Pub. Date: Dec. 3, 2015

(54) Streaming File System

(71) Applicants: John Esmet, Brooklyn, NY (US); Michael A. Bender, Syosset, NY (US); Martin L. Farach-Colton, New York, NY (US); Bradley C. Kuszmaul, Lexington, MA (US)

(72) Inventors: John Esmet, Brooklyn, NY (US); Michael A. Bender, Syosset, NY (US); Martin L. Farach-Colton, New York, NY (US); Bradley C. Kuszmaul, Lexington, MA (US)

(21) Appl. No.: 14/292,600

(22) Filed: May 30, 2014

(51) Int. Cl. G06F 17/30

(52) U.S. Cl. CPC G06F 17/30327; G06F 17/30917

(57) ABSTRACT

An indexing system and method for a filesystem, such as a database using the POSIX application programming interface, uses two fractal tree indices, a metadata index mapping the full pathname of files to file metadata, preferably data such as returned with a struct stat call, and a data index mapping pathname and block number to a datablock of a predetermined size, optionally a fixed size. The data index has keys ordered lexicographically, and the system and method allows for modifying existing keys, and creating new keys if there is no existing key, for writes smaller than the predetermined block size and for unaligned writes. The invention provides at least about an order of magnitude improvement in microdata operations (such as creating and scanning files smaller than a predetermined size, such as 512-byte files), and has write times comparable with existing file systems.

### PRIOR APPLICATIONS

This application claims priority to U.S. Provisional Application No. 61/828,989, filed 30 May 2013, the disclosure of which is incorporated herein by reference in its entirety.

### GOVERNMENT LICENSE RIGHTS

This invention was made with government support under DOE Grant DE-FG02-08ER25853 and by NSF grants 1058565, 0937860, and 0937829. The government has certain rights in the invention.

### BACKGROUND OF THE INVENTION

1. Field of the Invention

The invention relates to write-optimized file systems and databases and data structures containing the same.

2. The State of the Art

File system designers often must choose between good read performance and good write performance. For example, most of today's file systems employ some combination of B-trees and log-structured updates to achieve a good tradeoff between reads and writes.

At one extreme, update-in-place file systems keep data and metadata indexes up-to-date as soon as the data arrives. Such systems are described, for example, in: Card, R., T. Ts' o, and S. Tweedie, “Design and implementation of the Second Extended Filesystem,” In Proc. of the First Dutch International Symposium on Linux (1994). pp. 1-6; Cassandra wiki; http://wiki.apache.org/cassandra; 2008; and Sweeny, A., D. Coucette, W. Hu, C. Anderson, N. Nishimoto, and G. Peck, “Scalability in the XFS file system,” USENIX Conference (San Diego, Calif., January 1996), pp. 1-14. These file systems optimize for queries by, for example, attempting to keep all the data for a single directory together on disk. Data and metadata can be read quickly, especially for scans of related data that are together on disk, but the file system may require one or more disk seeks per insert, update, or delete (that is, for operations that write to the disk).

At the other extreme, so-called “logging” file systems maintain a circular buffer, called a “log,” into which data and metadata are written sequentially, and which allows updates to be written rapidly to disk. Logging ensures that files can be created and updated rapidly, but operations that read from the disk, such as queries, metadata lookups, and other read operations may suffer from the lack of an up-to-date index, or from poor locality in indexes that are spread through the log.

Large-block reads and writes, which are termed hereinafter “macrodata operations,” typically run close to disk bandwidth on most file systems. For small writes, which are termed hereinafter “microdata operations,” in which the bandwidth time to write the data is much smaller than a disk seek, the tradeoff becomes more severe. Examples of microdata operations include creating or destroying microfiles (small files), performing small writes within large files, and updating metadata (e.g., inode updates).

### SUMMARY OF THE INVENTION

In one aspect, this invention provides an index structure for a filesystem, comprising a metadata index in the form of a fractal tree comprising a mapping of the full pathname of a file in the filesystem to the metadata of the file, a data index in the form of a fractal tree comprising a mapping of the pathname and block number of a file in the filesystem to a data block of a predetermined size, said data index having keys, each key specifying a pathname and block number, said keys ordered lexicographically, and an application programming interface for said filesystem including a dictionary and a specification therefor, and a message in the dictionary specification, that, in the case that a filesystem command requires writing fewer bytes than said predetermined size, and in the case that a filesystem command comprises executing an unaligned disk write, modifies the key in the data index for such written data and, when such key is absent, creates the key. In various embodiments thereof, the index structure has a predetermined block size of 512 bytes, the lexicographic sorting is based firstly on directory depth and secondly on pathname, and preferably the metadata index maps to a structure containing the metadata of the file, the structure containing the information is typically stored in the “inode” of a Unix file and containing information returned in the “struct stat” call. This metadata is referred to herein as the “struct stat.”

In another aspect, this invention provides a method for indexing files in a filesystem, comprising, creating a metadata index in the form of a fractal tree mapping the full pathname of a file in the filesystem to metadata of said file, creating a data index in the form of a fractal tree mapping the pathname and block number of a file in the filesystem to a data block of a predetermined size, creating keys for said index, each key specifying a pathname and block number, and ordering said keys lexicographically in said data index, and in the case that a filesystem command requires writing fewer bytes than said predetermined size, and in the case that a filesystem command comprises executing an unaligned disk write, modifying the key in the data index for such written data and, when such key is absent, creating the key, and inserting said key in appropriate lexicographic order. In various embodiments thereof, the predetermined block size is 512 bytes, sorting occurs on the keys firstly by directory depth and secondly by pathname. In yet other embodiments, the method also includes creating a struct stat of the metadata of the file, and mapping said pathname and block number to the struct stat of said file, creating said key further by assigning a value to the key at a position offset in the block number associated therewith, and modifying the key further comprises changing an offset associated therewith by a newly specified length minus one byte.

### DETAILED DESCRIPTION

The present invention employs a combination of fractal tree indices. As implemented herein, a fractal tree is a data structure that implements a dictionary on key-value pairs. Let k be a key, and let v be a value. A dictionary, as shown in Table A, supports the following operations:

TABLE A

| Operation | Meaning |
|---|---|
| Insert (k, v) | associate value v with key k |
| v:= Search (k) | find the value associated with k |
| Delete (k) | remove key k and its value |
| k′:= Succ(k) | find the next (successive) key after k |
| k′:= Pred(k) | find the previous key before k |

These operations form the API (application programming interface) for both B-trees and Fractal Tree indexes.

The Fractal Tree index is a write-optimized indexing scheme, compared with a B-tree, meaning that under some conditions it can index data orders of magnitude faster than a B-tree. However, unlike many other write-optimized schemes, the Fractal Tree index can perform queries on indexed data at approximately the same speed as an unfragmented B-tree. Further, unlike some other schemes, a Fractal Tree index does not require that all the writes occur before all the reads: a read in the middle of many writes is fast and does not slow down the writes.

The B-tree has worst-case insert and search input/output (I/O) cost of O(log_{B}N) where B is the I/O block size. It is common for all internal nodes of a B-tree to be cached in memory, and so most operations require only about one disk I/O. If a query comprises a search or a successor query followed by k successor queries, referred to herein as a range query, the number of disk seeks is O(log_{B}N+k/B). In practice, if the keys are inserted in random order, the B-tree becomes fragmented and range queries can be an order of magnitude slower than it would be for keys inserted in sequential order.

An alternative to a B-tree is to append all insertions to the end of a file. This “append-to-file” structure optimizes insertions at the expense of queries. Because B inserts can be bundled into one disk write, the cost per operation is O(1/B) I/Os on average. However, performing a search requires reading the entire file, and thus takes O(N/B) I/Os in the worst case.

An LSM tree is described by P. O'Neil, E. Cheng, D. Gawlick, and E. O'Neil, “The log-structured merge-tree (LSM-tree),” Acta Informatica 33 (4), p. 351-385 (1996). The LSM tree also misses the optimal read-write tradeoff curve, requiring O(log²_{B}N) I/Os for queries. (The query time can be mitigated for point queries, but not range queries, by using a Bloom filter, see B. R. Bloom, “Space/time trade-offs in hash coding with allowable errors,” Commun. ACM 13 (7), p. 422-426 (1970); Cassandra, see Cassandra wiki at http://wiki.apache.org/cassandra/, 2008, which uses this approach.)

The Fractal Tree index provides much better write performance than a B-tree and much better query performance than the append-to-file or an LSM-tree. Indeed, a Fractal Tree index can be tuned to provide essentially the same query performance as an unfragmented B-tree with orders-of-magnitude improvements in insertion performance. The Fractal Tree index is based on ideas from the buffered repository tree (A. L. Buchsbaum, W. Goldwasser, S. Venkatasubramanian, and J. R. Westbrook, “On external memory graph traversal,” in SODA, Soc. Ind. and Appl. Math. (Philadelphia, 2000), pp. 859-860) and extended (see M. A. Bender, M. Farach-Colton, J. T. Fineman, Y. R. Fogel, B. C. Kuszmaul, and J. Nelson, “Cache-oblivious streaming B-trees,” in SPAA (ACM Symp. on Algorithms and Architectures) (San Diego, 2007), pp. 81-92, the disclosure of which is incorporated herein by reference) to provide cache-oblivious results.

As a brief description of the Fractal Tree index, consider a tree with branching factor b<B. Associate with each link a buffer of size B/b. When an insert (or delete) is injected into the system, place an insert (or delete) command into the appropriate outgoing buffer of the root. When the buffer gets full, flush the buffer and recursively insert the messages in the buffers in the child. As buffers on a root-leaf path fill, an insertion (or deletion) command makes its way toward its target leaf. During queries, all messages needed to answer a query are in the buffers on the root-leaf search path. When b=B^{0.5}, the query cost is O(log_{B}N), or within a constant of a B-tree and when caching is taken into account, the query time is comparable. On the other hand, the insertion time is O((log_{B}N)/B^{0.5}), which is orders of magnitude faster than a B-tree. This performance meets the optimal read-write tradeoff curve. (See G. S. Brodal and R. Fagerberg, “Lower bounds for external memory dictionaries,” in SODA (2003), pp. 546-554.)

In the present invention there are two Fractal Tree indexes: a metadata index and a data index. In addition, the present invention attends to many other important considerations such as ACID, MVCC, concurrency, and compression. Fractal Tree indexes do not fragment, no matter the insertion pattern.

A metadata index is a dictionary that maps pathnames to file metadata:
full pathname→size, owner, timestamps, etc.
   Files are broken up into data blocks of fixed size. In describing the present invention, a block size of 512 is chosen merely for purposes of describing the invention. This choice of block size worked well for microdata and reasonably well for large data. If one desires to tune for larger files, then one can chose a larger value for this parameter.

The blocks can be addressed by path name and block number, according to the data index, defined by:
pathname, block number→data[512]
   The last block in any file is padded out to the nearest multiple of 512 length. However, the padding does not have a substantial impact on storage space, because Fractal Tree indexes use compression.

Note that path names can be long and repetitive, and thus one might expect that addressing each block by pathname would require a substantial overhead in disk space. However, sorted path names have been found to compress by a factor of 20, making the disk-space overhead manageable.

The lexicographic ordering of the keys in the data index guarantees that the contents of a file are logically adjacent. Because Fractal Tree indexes do not fragment, logical adjacency translates into physical adjacency. Thus, a file can be read at near disk bandwidth. Indeed, the lexicographic ordering also places files in the same directory near each other on disk.

In the simple dictionary specification described above in Table A, an index may be changed by inserts and deletes. Consider, however, the case where fewer than 512 bytes need to be changed, or where a write is unaligned with respect to the data index block boundaries. Using the operations specified in Table 1, one would do a SEARCH(k) first, then change the value associated with k to reflect the update, and then a new block would be associated with k via an insertion. Searches are slow because they require disk seeks. Nevertheless, hereinbelow is described how to implement upsert operations to solve this problem with orders-of-magnitude performance improvements. The alternative would be to index every byte in the file system, which would be slow and have a large on-disk footprint.

In this invention, an UPSERT message is introduced into the dictionary specification to speed up such cases. A data index UPSERT is specified by UPSERT(K, P, L, D), where K is a key (in the case of the data index, K comprises a pathname and block number), and D is a value comprising exactly L bytes. If K is not in the dictionary, this UPSERT operation inserts K with a value of D at position P of the specified block. Unspecified bytes (before position P or starting any position starting at or after P+L) in the block are set to 0 (zero). Otherwise, the value associated with K is changed by replacing the bytes starting at position P by D. That is, the bytes before position P remain unchanged, the byte at position P+L and subsequent bytes remain unchanged, and the bytes from P to P+L−1 are changed to D. The UPSERT removes the search associated with the naive update method, and can sometimes provide an order-of-magnitude-or-more boost in performance.

As noted above, the data index maps from path and block number to data block. Although mapping this makes insertions and scans fast, especially on data in a directory tree, it makes the renaming of a directory slow, because the name of a directory is part of the key not only of every data block in every file in the directory, but for every file in the subtree rooted at that directory. One method for such implementation does a naive delete from the old location followed by an insert into the new location. An alternative method for such implementation is to move the subtrees around with only O(log² N) work. The pathnames can then be updated with a multicast upsert message (upsert messages are explained below).

The metadata index maps pathname to a so-called struct stat of its metadata, analogous to the struct stat structure in Unix. The struct stat stores all the metadata (i.e., permission bits, mode bits, timestamps, link count, etc.) that is output by a stat command. The stat struct is approximately 150 bytes uncompressed, and compresses well in practice.

The sort order in the metadata index differs from that of the data index. Paths are sorted lexicographically, preferably by (directory depth, pathname). This preferred sort order is useful for reading directories because all of the children for a particular directory appear sequentially after the parent. Additionally with this scheme, the maximum number of files is extremely large and is not fixed at formatting time (unlike, say, ext4, a journaling file system for LINUX, which needs to know how many inodes to create at format time and thus can run out of inodes if the default was not high enough).

In the present invention, a directory is an entry in the metadata index that maps the directory path to a struct stat with the O_DIRECTORY bit set. A directory exists iff (if and only if) there is a corresponding entry in this metadata index. A directory is empty iff the next entry in the metadata index does not share the directory path plus a slash as its prefix. Such an algorithm is easier than tracking whether the directory is empty in the metadata because it avoids the need to update the parent directory every time one of its children is removed.

Turning to the data index, a directory has no entry in the data index and does not keep a list of its children. Because of the sort order on the metadata index, reading the metadata for the files in a directory consists of a range query, and is thus efficient.

The present invention also defines a new set of upsert types that are useful for improving the efficiency of the metadata index. For example, a file created with O_CREAT and no O_EXCL can be encoded as a message that creates an entry in the metadata if it does not exist, or does nothing if it does. As another example, when a file is written at offset O for N bytes, a message can be injected into the metadata index that updates the modification time for the file, and optionally also updates the highest offset of the file to be O+N (i.e., its size). As yet another example, when a file is read, this invention can insert a message into the metadata index to update the access time efficiently. Some file systems have mount options to avoid such operations because updating the read time has a measurable decrease in performance in certain implementations. The present upsert messages share in common the property of avoiding a search into the metadata index by having encoded therein sufficient information to update the struct stat once the upsert message makes it to the leaf.

In the present invention, symbolic links are supported by storing the target pathname as the file data for the source pathname. For simplicity, the implementation of the invention as described herein does not exemplify supported hard links, although such can be implemented. For example, hard links can be emulated using the same algorithm described herein for symbolic links. In such a case, it would be desirable also to kept track of the link count for every file, so when a target pathname reaches a link count of zero, the file can finally be removed.

### EXAMPLES

The examples compare the performance of the instant invention to several traditional file systems. One advantage of the present invention is the ability to handle microwrites, so two kinds of microwrite benchmarks were measured: writing many small blocks spread throughout a large file; and writing many small files in a directory hierarchy. We also measured the performance of large writes, which is where traditional file systems do well, and although the present invention is relatively slower, this invention can be improved for large file creation.

All of these experiments were performed on a dual-Core OPTERON processor 1222 (Advanced Micro Devices, Inc., Sunnyvale, Calif.), running the UBUNTU 10.04 operating system (Canonical, Ltd., London, UK), with a 1 TB 7200rpm SATA disk drive (Hitachi, Ltd., Tokyo, Japan). This particular machine was chosen to demonstrate that the microdata problem can be addressed with relatively inexpensive hardware, compared with the machines used to run commercial databases.

### Example 1

Table 1 shows the time to create and scan 5 million 200-byte files, “microfiles,” in a balanced directory hierarchy in which each directory contained, at most, 128 entries. The first column shows the file system, the next three columns (under “creation”) show write performance in files per second for different numbers of threads, and the last column (under “scan”) is the scan rate (that is, the number of files per second traversed in a recursive walk).

TABLE 1

| | Creation | | | |
|---|---|---|---|---|
| File System | 1 thread | 4 threads | 8 threads | Scan |
| ext4 | 217 | 365 | 458 | 10,629 |
| XFS | 196 | 154 | 143 | 731 |
| Btrfs | 928 | 671 | 560 | 204 |
| ZFS | 44 | 194 | 219 | 303 |
| this invention | 17,088 | 16,960 | 16,092 | 143,006 |

“XFS” is a file system of Silicon Graphics, Inc., Sunnyvale, CA.
“Btrfs” is a jointly developed file system; see http://btrfs.wiki.kernel.org.
“ZFS” is a file system of Oracle Corp.

As shown in Table 1, the present invention is faster than the other file systems by one to two orders of magnitude for both reads and writes. Btrfs does well on writes, compared to the other traditional file systems, having the advantage of a log-structured file system for creating files, but suffers on reads because the resulting directory structure lacks spacial locality. Perhaps surprisingly, ZFS performs poorly, although it does better on a higher thread write workload. XFS performs poorly on file creation, but relatively well on scans. The ext4 file system performs better than the other traditional file systems on the scan, probably because its hashed directory scheme preserves locality on scans.

### Example 2

Earlier versions of files systems such as ext2 perform badly if one creates a single directory with many files in it. Table 2 shows ext4 versus the present invention in the creation and scan rates for one million empty files in the same directory; the performance is measured in files per second.

TABLE 2

| File System | create files/second | scan files/second |
|---|---|---|
| ext4 | 10,426 | 8,995 |
| present invention | 89,540 | 231,322 |

Table 2 shows that ext4 does reasonably well in this situation, compared with what would be expected with ext2, and, in fact, it does better than for the directory hierarchy. Nevertheless, in comparison, the present invention is slightly faster in one directory than in a hierarchy, and is more than an order of magnitude faster than ext4 in scanning files in this example.

### Example 3

Table 3 shows the performance when performing 575-byte nonoverlapping random writes into a 10 GB file. The size of 575-bytes was chosen because it is slightly larger than one 512-byte sector and is unaligned. (For example, compare J. Bent et al., “A checkpoint filesystem for parallel applications,” SC '09 Proceedings of the Conference on High Performance Computing Networking, Storage and Analysis, Article No. 21(2009), who employed a 47,001-byte block size in a similar benchmark for parallel file systems, stating that this size was “particularly problematic.”) Table 4 shows the microupdate write performance, in MB/s, comparing three file systems writing 575-byte nonoverlapping blocks and random offsets.

TABLE 3

| File System | write MB/s |
|---|---|
| Btrfs | 0.049 |
| ZFS | 0.032 |
| present invention | 2.01 |

As shown in Table 3, the traditional file systems achieve only tens of kilobytes per second for this workload, whereas the present invention achieves well over an order of magnitude better in comparison. Although the performance of the present invention in absolute terms seems small (utilizing only 2% of the bandwidth of the underlying disk drive), it is nearly two orders of magnitude better than the alternatives.

### Example 4

This example shows comparative performance when writing a single large file. In Table 4 are shown the comparative results for writing a 426 MB uncompressed tar file (MySQL source). The disk size and time were measured; the file bandwidth (MB/s) was calculated as the original size (426 MB) divided by the time taken to write, and the disk bandwidth was calculated as the size on the disk divided by the time.

TABLE 4

| File System | time (s) | size (MB) | file bandwidth | disk bandwidth |
|---|---|---|---|---|
| this invention | 15.74 | 72 | 27 | 1.7 |
| XFS | 5.53 | 426 | 77 | 77 |
| gzip-5 | 9.23 | 52 | 46 | 5.6 |

If it is assumed that XFS is achieving 100% of the write bandwidth at 77 MB/s, then the present invention achieves only about 35% of the underlying disk bandwidth. Because the implementation of present invention used in all of these examples compresses files using zlib (see http://zlib.net), the same compressor used in gzip (see www.gnu.org/software/gzip/). To try to understand how much of the comparative decrease in performance of the present invention in this example is from compression, as shown in the third row in Table 4, gzip was timed for compressing the same file. As shown in the table, that compression time is about the same as the difference in time between this invention and XFS. That is 15.74 s−9.23s=6.51s, comparable with 5.53s for XFS. For the workload used in this example, the present invention runs faster on a higher core-count server.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. An index structure for a filesystem, comprising:
a metadata index in the form of a fractal tree comprising a mapping of the full pathname of a file in the filesystem to the metadata of the file;
a data index in the form of a fractal tree comprising a mapping of the pathname and block number of a file in the filesystem to a data block of a predetermined size, said data index having keys, each key specifying a pathname and block number, said keys ordered lexicographically; and
an application programming interface for said filesystem including a dictionary and a specification therefor, and a message in the dictionary specification, that, in the case that a filesystem command requires writing fewer bytes than said predetermined size, and in the case that a filesystem command comprises executing an unaligned disk write, modifies the key in the data index for such written data and, when such key is absent, creates the key.

2. The index structure of claim 1, wherein said predetermined block size is 512 bytes.

3. The index structure of claim 1, wherein the lexicographic sorting is based firstly on directory depth.

4. The index structure of claim 3, wherein the lexicographic sorting is based secondly on pathname.

5. The index structure of claim 1, wherein the metadata index maps to a struct stat of the metadata of the file.

6. A method for indexing files in a filesystem, comprising:
creating a metadata index in the form of a fractal tree mapping the full pathname of a file in the filesystem to metadata of said file;
creating a data index in the form of a fractal tree mapping the pathname and block number of a file in the filesystem to a data block of a predetermined size;
creating keys for said index, each key specifying a pathname and block number, and ordering said keys lexicographically in said data index; and
in the case that a filesystem command requires writing fewer bytes than said predetermined size, and in the case that a filesystem command comprises executing an unaligned disk write, modifying the key in the data index for such written data and, when such key is absent, creating the key, and inserting said key in appropriate lexicographic order.

7. The method of claim 6, wherein the predetermined block size is 512 bytes.

8. The method claim 6, further comprising sorting the keys firstly on directory depth.

9. The method of claim 8, further comprising sorting the keys secondly on pathname.

10. The method of claim 6, further comprising creating a struct stat of the metadata of the file, and mapping said pathname and block number to the struct stat of said file.

11. The method of claim 6, wherein creating said key further comprises assigning a value to said key at a position offset in the block number associated therewith.

12. The method of claim 6, wherein modifying said key further comprises changing an offset associated therewith by a newly specified length minus one byte.
